(19) United States
(12) Patent Application Publication
(10) Pub. No.: US 2016/0236750 A1
(43) Pub. Date: Aug. 18, 2016

(54) BICYCLE DRIVE SYSTEM

(71) Applicant: Shimano Inc., Osaka (JP)

(72) Inventors: Atsuhiro EMURA, Osaka (JP); Sota YAMAGUCHI, Osaka (JP); Toshinari OISHI, Osaka (JP); Yusuke NISHIMOTO, Osaka (JP); Kazuki KOSHIYAMA, Osaka (JP)

(21) Appl. No.: 14/621,996

(22) Filed: Feb. 13, 2015

(51) Int. Cl. B62M 9/12; B62M 25/02; B62M 9/10

(52) U.S. Cl. CPC B62M 9/12; B62M 9/105; B62M 25/02

(57) ABSTRACT

A bicycle drive system includes a front sprocket assembly having a first front sprocket and a second front-sprocket. The first front-sprocket has a first front-tooth number that is the largest tooth number in the front sprocket assembly. The second front-sprocket has a second front-tooth number that is less than or equal to the first front-tooth number. The second front-sprocket is adjacent to the first front-sprocket without another sprocket intervening therebetween in an axial direction. The first front-tooth number is less than or equal to 40.

### BACKGROUND

1. Field of the Invention

This invention generally relates to a bicycle drive system. More specifically, the present invention relates to a sprocket assembly for a bicycle drive system.

2. Background Information

Bicycling is becoming an increasingly more popular form of recreation, as well as a means of transportation. Moreover, bicycling has become a very popular competitive sport for both amateurs and professionals. Whether the bicycle is used for recreation, transportation or competition, the bicycle industry is constantly improving the various components of the bicycle. One area that has been extensively redesigned over the years is the bicycle drive system. Specifically, manufacturers of bicycle components have been continually improving shifting performance of the various shifting components, such as shifters, derailleurs, chain and sprockets.

One particular component of the bicycle drive system that has been extensively redesigned in the past years is the sprocket assembly. Specifically, sprocket assemblies have been designed with improved sprockets to provide smoother shifting.

In view of the above, it will be apparent to those skilled in the art from this disclosure that there exists a need for an improved sprocket assembly of a bicycle drive system. This invention addresses this need in the art as well as other needs, which will become apparent to those skilled in the art from this disclosure.

### SUMMARY

Generally, the present disclosure is directed to various features of a bicycle drive system. An object of the present invention is to provide a bicycle drive system having a sprocket assembly to facilitate smooth, reliable shifting performance.

In view of the state of the know technology and in accordance with a first aspect of the present invention, a bicycle drive system is provided including a front sprocket assembly having a first front sprocket and a second front-sprocket. The first front-sprocket has a first front-tooth number that is the largest tooth number in the front sprocket assembly. The second front-sprocket has a second front-tooth number that is less than or equal to the first front-tooth number. The second front-sprocket is adjacent to the first front-sprocket without another sprocket intervening therebetween in an axial direction. The first front-tooth number is less than or equal to 40.

In accordance with a second aspect of the present invention, the bicycle drive system according to the first aspect is configured such that the first front-tooth number divided by the second front-tooth number is less than or equal to 1.4.

In accordance with a third aspect of the present invention, the bicycle drive system according to the first aspect is configured such that the first front-tooth number divided by the second front-tooth number is less than or equal to 1.2.

In accordance with a fourth aspect of the present invention, the bicycle drive system according to the first aspect is configured such that the first front-tooth number is less than or equal to 34.

In accordance with a fifth aspect of the present invention, the bicycle drive system according to the fourth aspect is configured such that the second front-tooth number is less than or equal to 30.

In accordance with a sixth aspect of the present invention, the bicycle drive system according to the first aspect is configured such to include a rear sprocket assembly including a first rear-sprocket having a first rear-tooth number less than or equal to 10 and a second rear-sprocket having a second rear-tooth number greater than or equal to 44.

In accordance with a seventh aspect of the present invention, the bicycle drive system according to the first aspect is configured such that the rear sprocket assembly includes at least 5 additional rear-sprockets positioned between the first rear-sprocket and the second rear-sprocket in an axial direction parallel to a rotational central axis of the rear sprocket assembly.

In accordance with an eighth aspect of the present invention, the bicycle drive system according to the seventh aspect is configured such that the rear sprocket assembly has a total of seven rear-sprockets.

In accordance with a ninth aspect of the present invention, the bicycle drive system according to the sixth aspect is configured such that the first rear-tooth number is 10, and the second rear-tooth number is 46.

In accordance with a tenth aspect of the present invention, the bicycle drive system according to the sixth aspect is configured such that the first rear-tooth number is 10, and the second rear-tooth number is 50.

In accordance with an eleventh aspect of the present invention, the bicycle drive system according to the sixth aspect is configured such that the first front-tooth number is 34, and the second front-tooth number is 30.

In accordance with a twelfth aspect of the present invention, the bicycle drive system according to the sixth aspect is configured such that the first front-tooth number is 32, and the second front-tooth number is 28.

In accordance with a thirteenth aspect of the present invention, the bicycle drive system according to the sixth aspect is configured such that the second rear-sprocket includes at least one shift assist projection.

In accordance with a fourteenth aspect of the present invention, the bicycle drive system according to the thirteenth aspect is configured such that the second rear-sprocket includes a plurality of shift assist projections.

In accordance with a fifteenth aspect of the present invention, the bicycle drive system according to the sixth aspect is configured to include a front shifting device disposed adjacent to the front sprocket assembly and a rear shifting device disposed adjacent to the rear sprocket assembly.

In accordance with a sixteenth aspect of the present invention, the bicycle drive system according to the fifteenth aspect is configured such that at least one of the front shifting device and the rear shifting device is configured to be operated by rotation of a bicycle crank arm.

In accordance with a seventeenth aspect of the present invention, the bicycle drive system according to the fifteenth aspect is configured such that at least one of the front shifting device and the rear shifting device is configured to be operated by movement of a bicycle control cable.

In accordance with an eighteenth aspect of the present invention, the bicycle drive system according to the fifteenth aspect is configured such that at least one of the front shifting device and the rear shifting device is configured to be operated in accordance with a prescribed shifting route.

In accordance with a nineteenth aspect of the present invention, the bicycle drive system according to the eighteenth aspect is configured such that the prescribed shifting route includes at least one of a prescribed up-shifting route and a prescribed down-shifting route.

In accordance with a twentieth aspect of the present invention, the bicycle drive system according to the nineteenth aspect is configured such that the prescribed shifting route includes the prescribed up-shifting route and the prescribed down-shifting route.

In accordance with a twenty-first aspect of the present invention, the bicycle drive system according to the sixth aspect is configured such that the first front-tooth number divided by the second front-tooth number is less than or equal to a large rear-sprocket tooth number of a large rear sprocket divided by a small rear-sprocket number of a small rear sprocket adjacent to the large rear sprocket without another rear sprocket intervening therebetween in the axial direction.

In accordance with a twenty-second aspect of the present invention, the bicycle drive system according to the sixth aspect is configured such that the first front-tooth number divided by the second front-tooth number is less than a large rear-sprocket tooth number of a large rear sprocket divided by a small rear-sprocket number of a small rear sprocket adjacent to the large rear sprocket without another rear sprocket intervening therebetween in the axial direction.

In accordance with a twenty-third aspect of the present invention, the bicycle drive system according to the sixth aspect is configured such that a large rear-sprocket tooth number of a large rear sprocket divided by a small rear-sprocket number of a small rear sprocket adjacent to the large rear sprocket without another rear sprocket intervening therebetween in the axial direction is greater than 1.27.

These and other objects, features, aspects and advantages will become apparent to those skilled in the art from the following detailed description, which, taken in conjunction with the annexed drawings, discloses selected embodiments.

### BRIEF DESCRIPTION OF THE DRAWINGS

Referring now to the attached drawings that form a part of this original disclosure:

FIG. 1 is a partial side elevational view of a bicycle including a bicycle drive system in accordance with an exemplary embodiment of the present invention;

FIG. 2 is a partial side elevational view of the bicycle drive system of FIG. 1 in which the bicycle chain is shown in phantom lines for clarity and in which a first front-sprocket has forty teeth and a second front-sprocket has thirty teeth;

FIG. 3 is a partial side elevational view of the bicycle drive system of FIG. 2 in which a first front-sprocket has thirty-four teeth and a second front-sprocket has thirty teeth;

FIG. 4 is a partial side elevational view of the bicycle drive system of FIG. 2 in which a first rear-sprocket has ten teeth and a second rear-sprocket has forty-six teeth;

FIG. 5 is a partial side elevational view of the bicycle drive system of FIG. 2 in which a first rear-sprocket has ten teeth and a second rear-sprocket has fifty teeth;

FIG. 6 is a partial side elevational view of the bicycle drive system of FIG. 5 in which a first front-sprocket has thirty-four teeth and a second front-sprocket has thirty teeth;

FIG. 7 is a partial side elevational view of the bicycle drive system of FIG. 5 in which a first front-sprocket has thirty-two teeth and a second front-sprocket has twenty-eight teeth;

FIG. 8 is a table of teeth ratios for a bicycle drive system in which a first front-sprocket has thirty-four teeth and a second front-sprocket has thirty teeth for a first configuration of a rear sprocket assembly;

FIG. 9 is a table of teeth ratios for a bicycle drive system in which a first front-sprocket has thirty-two teeth and a second front-sprocket has twenty-eight teeth for a first configuration of a rear sprocket assembly;

FIG. 10 is a table of teeth ratios for a bicycle drive system in which a first front-sprocket has thirty-four teeth and a second front-sprocket has thirty teeth for a second configuration of a rear sprocket assembly;

FIG. 11 is a table of teeth ratios for a bicycle drive system in which a first front-sprocket has thirty-four teeth and a second front-sprocket has thirty teeth for a third configuration of a rear sprocket assembly;

FIG. 12 is a table of teeth ratios for a bicycle drive system in which a first front-sprocket has thirty-two teeth and a second front-sprocket has twenty-eight teeth for a fourth configuration of a rear sprocket assembly;

FIG. 13 is a table of teeth ratios for a bicycle drive system in which a first front-sprocket has thirty teeth and a second front-sprocket has twenty-six teeth for a fourth configuration of a rear sprocket assembly;

FIG. 14 is a table of teeth ratios for a bicycle drive system in which a first front-sprocket has thirty teeth and a second front-sprocket has twenty-six teeth for a fifth configuration or a rear sprocket assembly;

FIG. 15 is a table of teeth ratios for a bicycle drive system in which a first front-sprocket has twenty-eight teeth and a second front-sprocket has twenty-four teeth for a sixth configuration of a sprocket assembly;

FIG. 16 is a partial side elevational view of the bicycle drive system of FIG. 1 including front and rear electrical shifting devices;

FIG. 17A is side elevational view of a conventional sprocket, and FIG. 17B is a side elevational view of a sprocket of FIG. 1 including a shift assist projection;

FIG. 18 is a crank arm assembly of FIG. 1 configured to initiate operation of an assist device; and

FIG. 19 is an exploded view of an assist device configured to operate a shifting device.

### DETAILED DESCRIPTION OF EXEMPLARY EMBODIMENTS

Selected exemplary embodiments will now be explained with reference to the drawings. It will be apparent to those skilled in the art from this disclosure that the following descriptions of the exemplary embodiments are provided for illustration only and not for the purpose of limiting the invention as defined by the appended claims and their equivalents.

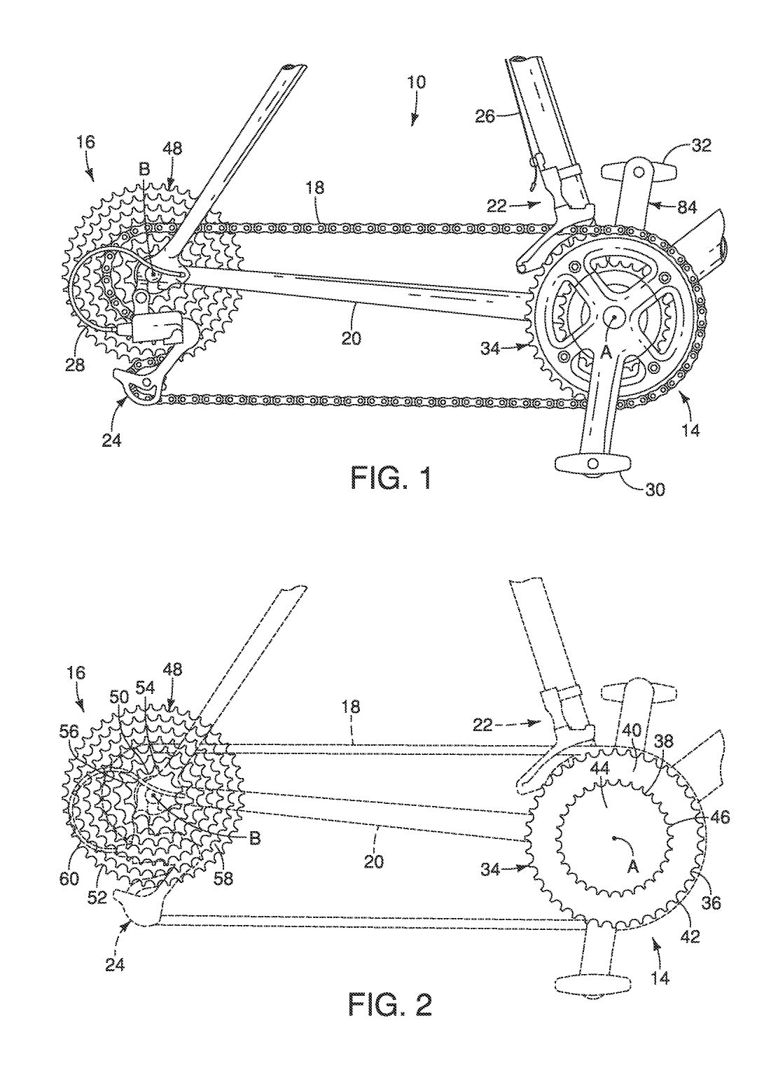

Referring initially to FIG. 1, a bicycle 10 is illustrated that is equipped with, among other things, a front crankset 14, a rear gear cassette 16, a drive chain 18 (e.g., a chain) that connects the front crankset 14 to the rear gear cassette 16. The front crankset 14 is rotatably supported to a bicycle frame 20 by a conventional bottom bracket in a conventional manner. The bicycle 10 further includes a front shifting device, such as a front derailleur 22, and a rear shifting device, such as a rear derailleur 24, for shifting the chain 18 laterally to change gears. The front and rear derailleurs 22 and 24 are operatively connected to shifters (not shown) by cables 26 and 28 for operating the front and rear derailleurs 22 and 24 in a conventional manner.

The bicycle 10 is conventional, except for the front crankset 14 and rear gear cassette 16 as discussed below. Thus, the bicycle 10 will not be discussed and/or illustrated in detail herein, except as related to the present invention. Rather, it will be apparent to those skilled in the art from this disclosure that the bicycle 10 includes various conventional bicycle components such as wheels, shifters, a handle etc. coupled to the bicycle frame 20 in a conventional manner. Moreover, it will be apparent to those skilled in the art from this disclosure that various modifications can be made to the bicycle 10 and its various components without departing from the present invention, as described and illustrated herein. Finally, it will be apparent to those skilled in the art from this disclosure that the bicycle 10 can be used on various types of bicycle such as road or mountain bicycles as needed and/or desired.

As illustrated in FIG. 1, the front crankset 14, the rear gear cassette 16, and the rear derailleur 24 engage with the chain 18 to form a bicycle drive system of the bicycle 10 that transmits a rotation of pedals 30 and 32 of the front crankset 14 to the rear gear cassette 16 and a rear wheel (not shown). The rear derailleur 24 is fixedly coupled to a chain stay of the bicycle frame 20. In the illustrated embodiment, the front and rear derailleurs 22 and 24 are conventional front and rear derailleur devices. Thus, a detailed description of the front and rear derailleurs 22 and 24 will be omitted for the sake of brevity. Of course, the front and rear derailleurs 22 and 24 can be different types of front and rear derailleurs, as needed or desired.

As illustrated in FIGS. 1 and 2, the bicycle drive system in accordance with an exemplary embodiment of the present invention includes a front crankset 14. The front crankset 14 includes a front sprocket assembly 34 having any suitable number of sprockets. In the illustrated embodiment, the front sprocket assembly 34 includes a first front-sprocket 36 and a second front-sprocket 38.

The first front-sprocket 36 includes a body 40, which is rotatable around a center rotational axis A, and a plurality of teeth 42 provided along a peripheral portion of the body 40, as shown in FIGS. 1 and 2. The body 40 is formed of an annular plate-shaped member made, for example, of iron, aluminum, titanium, or any other metal or a carbon fiber reinforced material or any other non-metallic material. The first front-sprocket 36 has a first front-tooth number that is the largest tooth number in the front sprocket assembly 34. The first front-tooth number is less than or equal to forty (40). In the exemplary embodiment illustrated in FIGS. 1 and 2, the first front-sprocket 36 has forty (40) teeth 42.

The second front-sprocket 38 includes a body 44, which is rotatable around the center rotational axis A, and a plurality of teeth 46 provided along a peripheral portion of the body 44, as shown in FIGS. 1 and 2. The second front-sprocket 38 is disposed adjacent to the first front-sprocket 36 without another sprocket being disposed or intervening therebetween in the axial direction, i.e., in the direction of the rotational axis A. The body 44 is formed of an annular plate-shaped member made, for example, of iron, aluminum, titanium, or any other metal or a carbon fiber reinforced material or any other non-metallic material. The second front-sprocket has a second front-tooth number that is less than or equal to the first front-tooth number. The first front-tooth number divided by the second front-tooth number is preferably less than or equal to 1.4. More preferably, the first front-tooth number divided by the second front-tooth number is preferably less than or equal to 1.2. In the exemplary embodiment illustrated in FIGS. 1 and 2, the second front-sprocket 38 has thirty (30) teeth 44.

In another exemplary embodiment illustrated in FIGS. 1 to 3, the bicycle drive system includes the rear gear cassette 16, which includes a rear sprocket assembly 48 having a first rear-sprocket 50 and a second rear-sprocket 52.

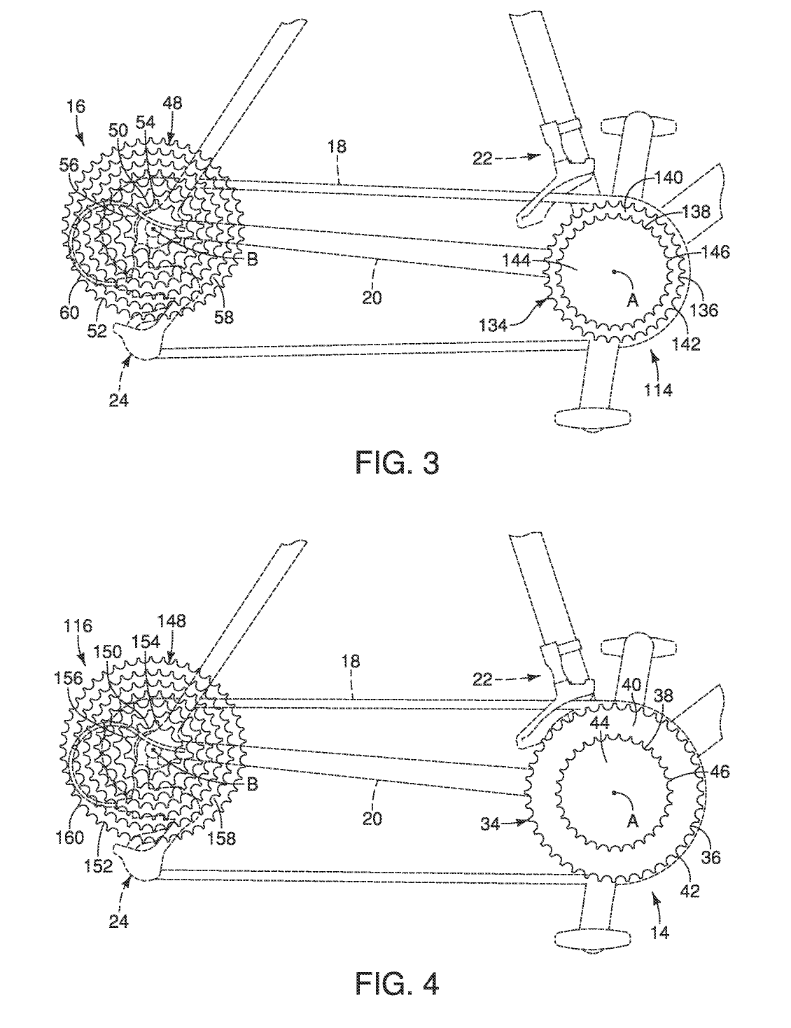

The first rear-sprocket 50 includes a body 54, which is rotatable around a center rotational axis B, and a plurality of teeth 56 provided along a peripheral portion of the body 54, as shown in FIGS. 2 and 3. The body 54 is formed of an annular plate-shaped member made, for example, of iron, aluminum, titanium, or any other metal or a carbon fiber reinforced material or any other non-metallic material. The first rear-sprocket 50 has a first rear-tooth number that is less than or equal to ten (10). In the exemplary embodiment illustrated in FIGS. 2 and 3, the first rear-sprocket 50 has ten (10) teeth 56.

The second rear-sprocket 52 includes a body 58, which is rotatable around the center rotational axis B, and a plurality of teeth 60 provided along a peripheral portion of the body 58, as shown in FIG. 3. At least five sprockets are disposed between the first rear-sprocket 50 and the second rear-sprocket 52 in an axial direction parallel to the center rotational axis B of the rear sprocket assembly 16. As illustrated in FIG. 3, five sprockets are disposed between the first and second rear-sprockets 50 and 52 such that the rear sprocket assembly 48 has a total of seven rear sprockets. The body 58 is formed of an annular plate-shaped member made, for example, of iron, aluminum, titanium, or any other metal or a carbon fiber reinforced material or any other non-metallic material. The second rear-sprocket 52 has a second rear-tooth number greater than or equal to forty-four (44). In the exemplary embodiment illustrated in FIG. 3, the second rear-sprocket 52 has forty-four (44) teeth 60.

In another exemplary embodiment illustrated in FIG. 3, a front crankset 114 includes a front sprocket assembly 134 having a first front-sprocket 136 and a second front-sprocket 138.

The first front-sprocket 136 includes a body 140, which is rotatable around a center rotational axis A, and a plurality of teeth 142 provided along a peripheral portion of the body 140, as shown in FIG. 3. The body 140 is formed of an annular plate-shaped member made, for example, of iron, aluminum, titanium, or any other metal or a carbon fiber reinforced material or any other non-metallic material. The first front-sprocket 136 has a first front-tooth number that is the largest tooth number of the sprockets in the front sprocket assembly 134. The first front-tooth number is less than or equal to forty (40), and more preferably the first front-tooth number is less than or equal to thirty-four (34). In the exemplary embodiment illustrated in FIG. 3, the first front-sprocket 136 has thirty-four (34) teeth 142.

The second front-sprocket 138 includes a body 144, which is rotatable around the center rotational axis A, and a plurality of teeth 146 provided along a peripheral portion of the body 144, as shown in FIG. 3. The second front-sprocket 138 is disposed adjacent to the first front-sprocket 136 without another sprocket being disposed or intervening therebetween in the axial direction, i.e., in the direction of the rotational axis A. The body 144 is formed of an annular plate-shaped member made, for example, of iron, aluminum, titanium, or any other metal or a carbon fiber reinforced material or any other non-metallic material. In the exemplary embodiment illustrated in FIG. 3, the second front-sprocket 138 has thirty (30) teeth 144.

In another exemplary embodiment illustrated in FIG. 4, the bicycle drive system includes a rear gear cassette 116, which includes a rear sprocket assembly 148 having a first rear-sprocket 150 and a second rear-sprocket 152. The front sprocket assembly 14 is described above with reference to FIGS. 1 and 2.

The first rear-sprocket 150 includes a body 154, which is rotatable around a center rotational axis B, and a plurality of teeth 156 provided along a peripheral portion of the body 154, as shown in FIG. 4. The body 154 is formed of an annular plate-shaped member made, for example, of iron, aluminum, titanium, or any other metal or a carbon fiber reinforced material or any other non-metallic material. The first rear-sprocket 150 has a first rear-tooth number that is less than or equal to ten (10). In the exemplary embodiment illustrated in FIG. 4, the first rear-sprocket 150 has ten (10) teeth 156.

The second rear-sprocket 152 includes a body 158, which is rotatable around the center rotational axis B, and a plurality of teeth 160 provided along a peripheral portion of the body 158, as shown in FIG. 4. At least five sprockets are disposed between the first rear-sprocket 150 and the second rear-sprocket 152 in an axial direction parallel to the center rotational axis B of the rear sprocket assembly 116. As illustrated in FIG. 4, five sprockets are disposed between the first and second rear sprockets 150 and 152 such that the rear sprocket assembly 148 has a total of seven rear sprockets. The body 158 is formed of an annular plate-shaped member made, for example, of iron, aluminum, titanium, or any other metal or a carbon fiber reinforced material or any other non-metallic material. The second rear-sprocket 152 has a second-rear tooth number greater than or equal to forty-four (44). In the exemplary embodiment illustrated in FIG. 4, the second rear-sprocket 152 has forty-six (46) teeth 160.

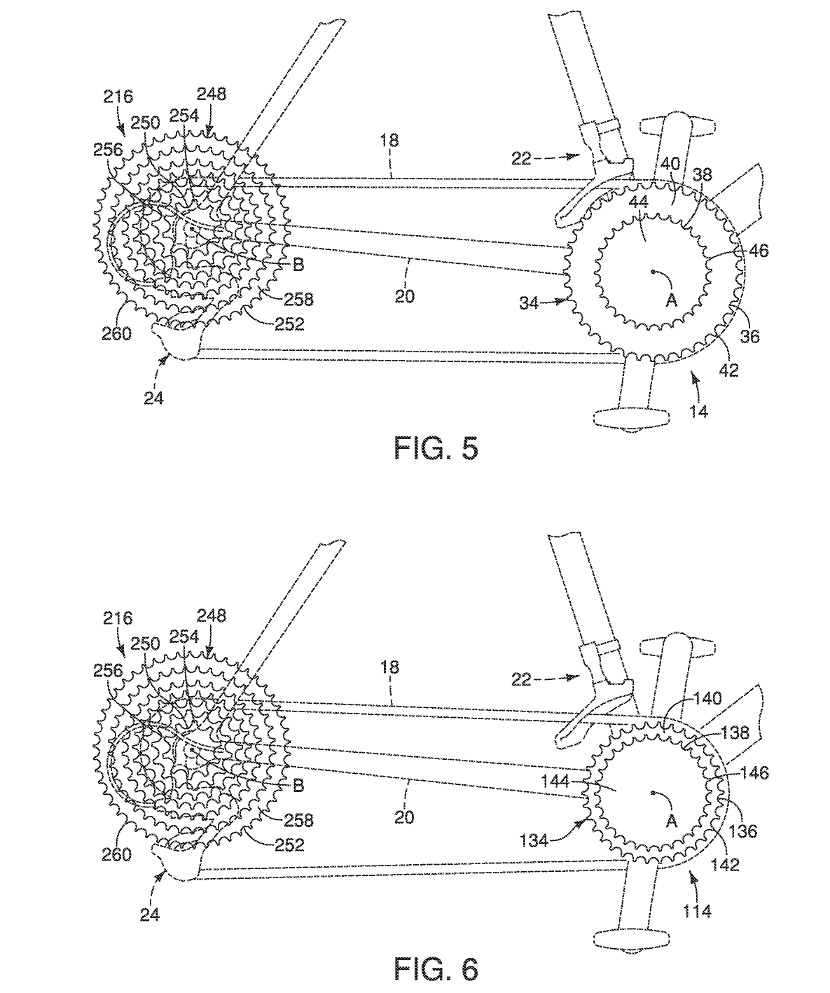

In another exemplary embodiment illustrated in FIGS. 5 to 7, the bicycle drive system includes a rear gear cassette 216, which includes a rear sprocket assembly 248 having a first rear-sprocket 250 and a second rear-sprocket 252.

The first rear-sprocket 250 includes a body 254, which is rotatable around a center rotational axis B, and a plurality of teeth 256 provided along a peripheral portion of the body 254, as shown in FIGS. 5 to 7. The body 254 is formed of an annular plate-shaped member made, for example, of iron, aluminum, titanium, or any other metal or a carbon fiber reinforced material or any other non-metallic material. The first rear-sprocket 250 has a first rear-tooth number that is less than or equal to ten (10). In the exemplary embodiment illustrated in FIGS. 5 to 7, the first rear-sprocket 250 has ten (10) teeth 256.

The second rear-sprocket 252 includes a body 258, which is rotatable around the center rotational axis B, and a plurality of teeth 260 provided along a peripheral portion of the body 258, as shown in FIGS. 5 to 7. At least five sprockets are disposed between the first rear-sprocket 250 and the second rear-sprocket 252 in an axial direction parallel to the center rotational axis B of the rear sprocket assembly 216. As illustrated in FIGS. 5 to 7, five sprockets are disposed between the first and second rear sprockets 250 and 252 such that the rear sprocket assembly 248 has a total of seven rear sprockets. The body 258 is formed of an annular plate-shaped member made, for example, of iron, aluminum, titanium, or any other metal or a carbon fiber reinforced material or any other non-metallic material. The second rear-sprocket 252 has a second rear-tooth number greater than or equal to forty-four (44). In the exemplary embodiment illustrated in FIGS. 5 to 7, the second rear-sprocket 252 has fifty (50) teeth 260.

With reference to the exemplary embodiment illustrated in FIG. 5, the front sprocket assembly 34 of the front crankset 14 is configured substantially similarly as described above with reference to FIGS. 1 and 2.

With reference to FIG. 6, the front sprocket assembly 134 of the front crankset 114 is configured substantially similarly as described above with reference to FIG. 3.

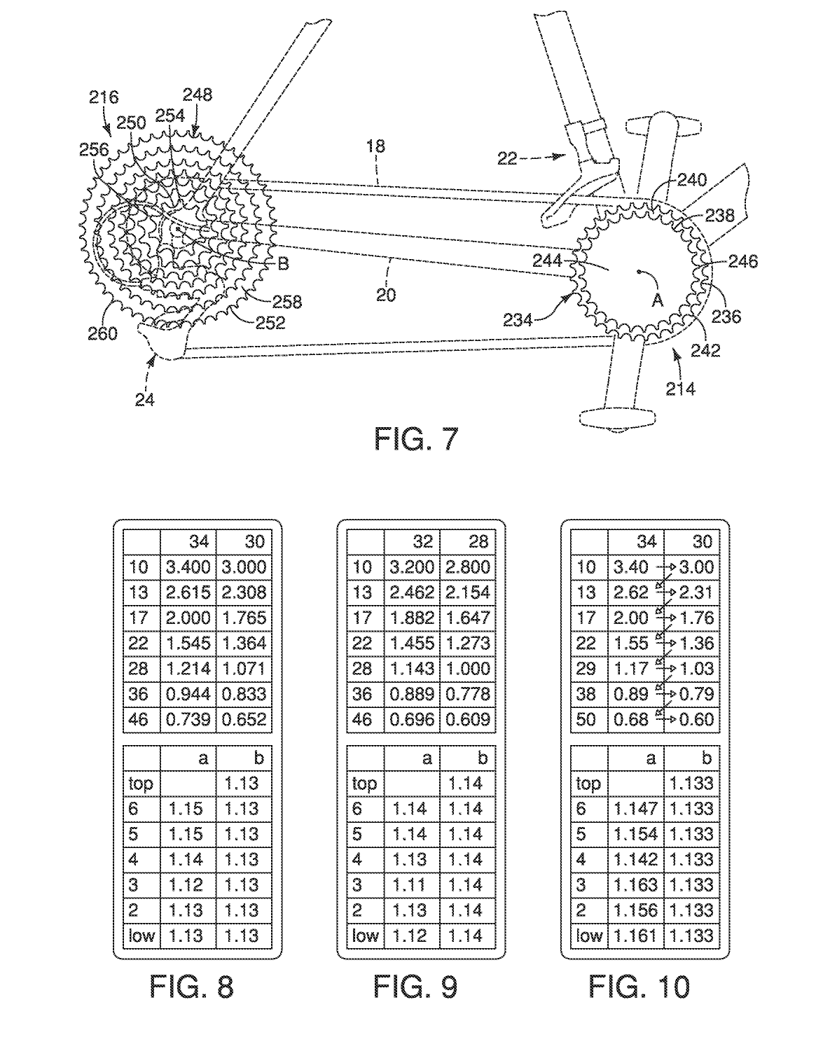

In another exemplary embodiment illustrated in FIG. 7, a front crankset 214 includes a front sprocket assembly 234 having a first front-sprocket 236 and a second front-sprocket 238.

The first front-sprocket 236 includes a body 240, which is rotatable around a center rotational axis A, and a plurality of teeth 242 provided along a peripheral portion of the body 240, as shown in FIG. 7. The body 240 is formed of an annular plate-shaped member made, for example, of iron, aluminum, titanium, or any other metal or a carbon fiber reinforced material or any other non-metallic material. The first front-sprocket 236 has a first front-tooth number that is the largest tooth number of the sprockets in the front sprocket assembly 234. The first front-tooth number is less than or equal to forty (40), and more preferably the first front-tooth number is less than or equal to thirty-four (34). In the exemplary embodiment illustrated in FIG. 7, the first front-sprocket 236 has thirty-two (32) teeth 242.

The second front-sprocket 238 includes a body 244, which is rotatable around the center rotational axis A, and a plurality of teeth 246 provided along a peripheral portion of the body 244, as shown in FIG. 7. The second front-sprocket 238 is disposed adjacent to the first front-sprocket 236 without another sprocket being disposed or intervening therebetween in the axial direction, i.e., in the direction of the rotational axis A. The body 244 is formed of an annular plate-shaped member made, for example, of iron, aluminum, titanium, or any other metal or a carbon fiber reinforced material or any other non-metallic material. In the exemplary embodiment illustrated in FIG. 7, the second front-sprocket 238 has twenty-eight (28) teeth 246.

FIGS. 8 to 15 are tables of teeth ratios for various exemplary front and rear sprocket assembly configurations. The top row of the upper portion of each of the tables is the tooth number of each front sprocket of the front sprocket assembly. The left column of the upper portion of each of the tables is the tooth number of each rear sprocket of the rear sprocket assembly. The corresponding table entries are the ratio of the number of teeth of the front sprocket to the number of teeth of the rear sprocket, i.e., the number of teeth of the front sprocket divided by the number of teeth of the rear sprocket.

FIG. 8 illustrates a front sprocket assembly having a first front-sprocket having thirty-four teeth and a second front-sprocket having thirty teeth. The rear sprocket assembly includes a first rear-sprocket having ten teeth and a second rear-sprocket having forty-six teeth. The intervening rear sprockets between the first and second rear-sprockets have thirteen, seventeen, twenty-two, twenty-eight and thirty-six teeth, respectively.

FIG. 9 illustrates a front sprocket assembly having a first front-sprocket having thirty-two teeth and a second front-sprocket having twenty-eight teeth. The rear sprocket assembly includes a first rear-sprocket having ten teeth and a second rear-sprocket having forty-six teeth. The intervening rear sprockets between the first and second rear-sprockets have thirteen, seventeen, twenty-two, twenty-eight and thirty-six teeth, respectively.

FIG. 10 illustrates a front sprocket assembly having a first front-sprocket having thirty-four teeth and a second front-sprocket having thirty teeth. The rear sprocket assembly includes a first rear-sprocket having ten teeth and a second rear-sprocket having fifty teeth. The intervening rear sprockets between the first and second rear-sprockets have thirteen, seventeen, twenty-two, twenty-nine and thirty-eight teeth, respectively.

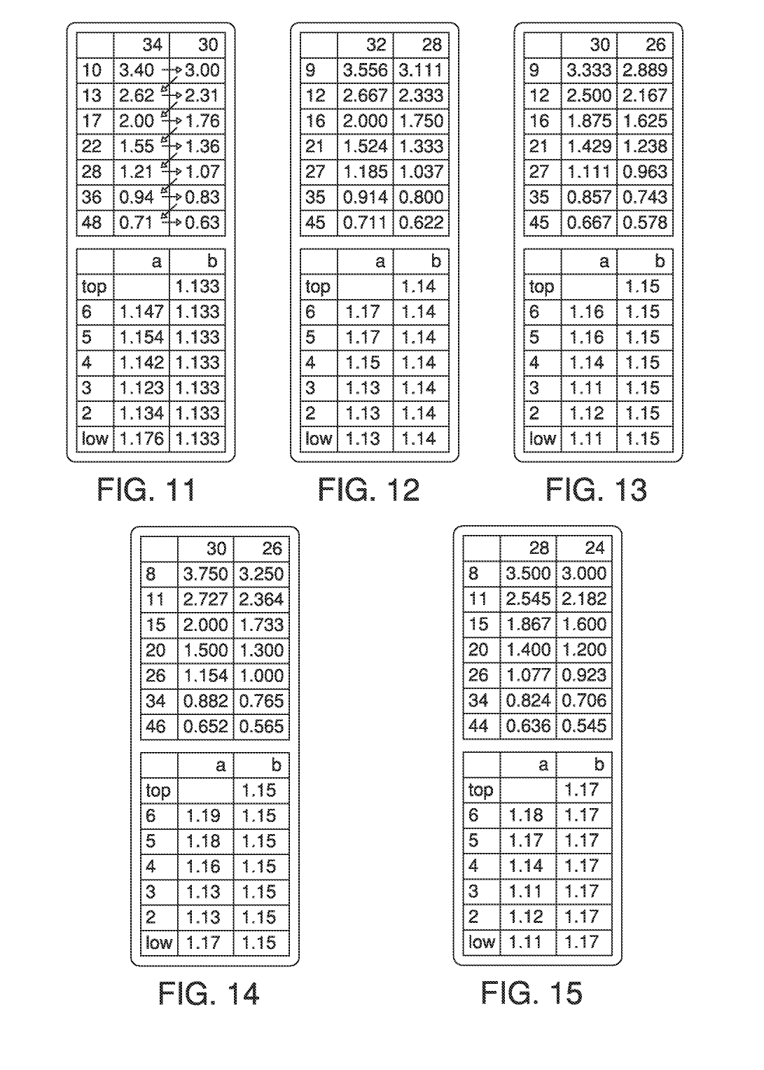

FIG. 11 illustrates a front sprocket assembly having a first front-sprocket having thirty-four teeth and a second front-sprocket having thirty teeth. The rear sprocket assembly includes a first rear-sprocket having ten teeth and a second rear-sprocket having forty-eight teeth. The intervening rear sprockets between the first and second rear-sprockets have thirteen, seventeen, twenty-two, twenty-eight and thirty-six teeth, respectively.

FIG. 12 illustrates a front sprocket assembly having a first front-sprocket having thirty-two teeth and a second front-sprocket having twenty-eight teeth. The rear sprocket assembly includes a first rear-sprocket having nine teeth and a second rear-sprocket having forty-five teeth. The intervening rear sprockets between the first and second rear-sprockets have twelve, sixteen, twenty-one, twenty-seven and thirty-five teeth, respectively.

FIG. 13 illustrates a front sprocket assembly having a first front-sprocket having thirty teeth and a second front-sprocket having twenty-six teeth. The rear sprocket assembly includes a first rear-sprocket having nine teeth and a second rear-sprocket having forty-five teeth. The intervening rear sprockets between the first and second rear-sprockets have twelve, sixteen, twenty-one, twenty-seven and thirty-five teeth, respectively.

FIG. 14 illustrates a front sprocket assembly having a first front-sprocket having thirty teeth and a second front-sprocket having twenty-six teeth. The rear sprocket assembly includes a first rear-sprocket having eight teeth and a second rear-sprocket having forty-six teeth. The intervening rear sprockets between the first and second rear-sprockets have eleven, fifteen, twenty, twenty-six and thirty-four teeth, respectively.

FIG. 15 illustrates a front sprocket assembly having a first front-sprocket having twenty-eight teeth and a second front-sprocket having twenty-four teeth. The rear sprocket assembly includes a first rear-sprocket having eight teeth and a second rear-sprocket having forty-four teeth. The intervening rear sprockets between the first and second rear-sprockets have eleven, fifteen, twenty, twenty-six and thirty-four teeth, respectively.

The lower portion of each of the tables of FIGS. 8 to 15 includes an “a” column corresponding to the number of teeth of the larger front sprocket and a “b” column corresponding to the number of teeth of the smaller front sprocket. The left column of the lower portion of each of the tables is the sprocket number from the sprocket with the fewest teeth to the sprocket with the largest number of teeth. Accordingly, the “top” row corresponds to the sprocket having the fewest teeth, with the “6” row being the next sprocket adjacent to the “top” sprocket in an axial direction. The “low” sprocket corresponds to the sprocket having the greatest number of teeth and having the largest axial spacing from the “top” sprocket.

The upper portion of the table of FIG. 8 includes a column “34” corresponding to the first front-tooth number and a column “30” corresponding to the second front-tooth number. The row “10” corresponds to the first rear-tooth number and the row “46” corresponds to the second rear-tooth number. The rows “13”, “17”, “22”, “28” and “36” correspond to the five sprockets disposed between the first and second rear-sprockets. The entries “3.400” and “3.000” correspond to the ratio of the first front-tooth number to the first rear tooth number (34/10=3.400) and the ratio of the second front tooth number to the first rear-tooth number (30/10=3.000), respectively. The next row is the ratio of the first front-tooth number to the number of teeth of the next adjacent rear sprocket, i.e., 34/13=2.615 and 30/13=2.308, respectively. The remaining entries are determined in a similar manner.

The “a” column of FIG. 8 is the ratio of the ratio of the second front tooth number to the first rear-tooth number of the preceding smaller rear sprocket to the ratio of the first front tooth-number to the tooth number of the current rear sprocket. Accordingly, there is no “a” entry for the top (or smallest) rear sprocket as there is no smaller or preceding rear sprocket. The “a” entry for the 6 (or 13 tooth) rear sprocket is 1.15, i.e., 3.000 (30/10) divided by 2.615 (34/13). The “a” entry for the 5 (or 17 tooth) rear sprocket is 1.15, i.e., 2.308 (30/13) divided by 2.000 (34/17). The remaining “a” column entries are determined in a similar manner.

The “b” column of FIG. 8 is the ratio of the ratio of the first front-tooth number to the rear-tooth number of the current rear sprocket to the ratio of the second rear-tooth number to the tooth number of the current rear sprocket. The “b” entry for the “top” (10 tooth) rear sprocket is 1.13, i.e., 3.400 (34/10) divided by 3.000 (30/10). The “b” entry for the “6” (13 tooth) rear sprocket is 1.13, i.e., 2.615 (34/13) divided by 2.308 (30/13). The remaining “b” column entries are determined in a similar manner.

The first front-tooth number divided by the second front-tooth number is preferably less than or equal to a large rear-sprocket tooth number of a large rear sprocket divided by a small rear-sprocket number of a small rear sprocket adjacent to the large rear sprocket without another rear sprocket intervening therebetween in the axial direction. As illustrated in FIG. 10, for example, the first front-tooth number is 34 and the second front-tooth number is 30. The first front-tooth number divided by the second front-tooth number is 1.13 (34/30). The large rear-sprocket tooth number is 50 and the small rear-sprocket tooth number of the adjacent sprocket without any intervening sprockets is 38. The large rear-sprocket tooth number divided by the small rear-sprocket tooth number of the adjacent sprocket without any intervening sprockets therebetween in the axial direction is 1.31 (50/38). Thus, 1.13 is less than or equal to 1.31.

The first front-tooth number divided by the second front-tooth number is preferably less than a large rear-sprocket tooth number of a large rear sprocket divided by a small rear-sprocket number of a small rear sprocket adjacent to the large rear sprocket without another rear sprocket intervening therebetween in the axial direction. As illustrated in FIG. 11, for example, the first front-tooth number is 34 and the second front-tooth number is 30. The first front-tooth number divided by the second front-tooth number is 1.13 (34/30). The large rear-sprocket tooth number is 48 and the small rear-sprocket tooth number of the adjacent sprocket without any intervening sprockets is 36. The large rear-sprocket tooth number divided by the small rear-sprocket tooth number of the adjacent sprocket without any intervening sprockets therebetween in the axial direction is 1.33 (48/36). Thus, 1.13 is less than 1.33.

A large rear-sprocket tooth number of a large rear sprocket divided by a small rear-sprocket number of a small rear sprocket adjacent to the large rear sprocket without another rear sprocket intervening therebetween in the axial direction is preferably greater than 1.27. As illustrated in FIG. 14, for example, the large rear-sprocket tooth number is 46 and the small rear-sprocket tooth number of the adjacent sprocket without any intervening sprockets therebetween in the axial direction is 34. The large rear-sprocket tooth number divided by the small rear-sprocket tooth number of the adjacent sprocket without any intervening sprockets therebetween in the axial direction is 1.35 (46/34). Thus, 1.35 is greater than 1.27.

The upper and lower portions of the tables of FIGS. 9 to 15 are determined in a similar manner to FIG. 8 as described above. Additionally, the upper portions of FIGS. 10 and 11 illustrate a prescribed shifting route. More specifically, the arrows indicate a prescribed down-shifting route. At least one of the front shifting device 22 and the rear shifting device 24 is configured to be operated in accordance with a prescribed shifting route. The prescribed shifting route includes at least one of a prescribed up-shifting route and a prescribed down-shifting route. Preferably, the prescribed shifting route includes the prescribed up-shifting route and the prescribed down-shifting route. For clarity, a prescribed up-shifting route is not shown, although the prescribed up-shifting route is the reverse of the illustrated prescribed down-shifting route. For example, as illustrated in FIG. 10, the prescribed down-shifting route is to shift the chain from the first front-sprocket to the second front-sprocket while retaining the chain on the same rear sprocket. The next shift results in the chain shifting from the second front-sprocket to the first front-sprocket and from the rear sprocket to the adjacent larger rear sprocket. For example, when the current chain position is on the 5 gear (17 tooth) rear sprocket and the first (34 tooth) front-sprocket, the prescribed down-shift is to the second (30 tooth) front-sprocket while remaining on the 5 gear (17 tooth) rear sprocket. The next prescribed down-shift is back to the first (34 tooth) front sprocket and to the 6 gear (22 tooth) rear sprocket. The prescribed down-shifting route follows the arrows illustrated in the upper portion of FIG. 10. The prescribed up-shifting route is the reverse of the arrows illustrated in the upper portion of FIG. 10.

The front and rear sprockets rotate in a rotational direction (clockwise as illustrated in FIGS. 1 to 8 and 16) to drive a bicycle chain 18 in a drive direction. During a chain shifting process on the front sprocket assembly, the chain 18 is shifted from one of the front sprockets to the next adjacent one of the front sprockets by the front derailleur 22 moving the chain laterally in an axial direction relative to the center rotational axis A of the front sprocket assembly. During a chain shifting process on the rear sprocket assembly, the chain 18 is shifted from one of the rear sprockets to the next adjacent one of the rear sprockets by the rear derailleur 24, thereby moving the chain in an axial direction relative to the center rotational axis B of the rear sprocket assembly. Bicycle chains are well known, and thus, a bicycle chain will not be illustrated in detail herein. Of course, the bicycle chain is a continuous loop that has a plurality of inner link plates and a plurality of outer link plates that are pivotally connected to each other by articulation chain pins and chain rollers. From the center of each of the chain rollers to the center of the next chain roller is about one-half inch (12.7 mm). This dimension is known as the “pitch” of the chain. The bicycle chain can be any chain that is used with a bicycle sprocket. Thus, the chain will not be described in further detail herein.

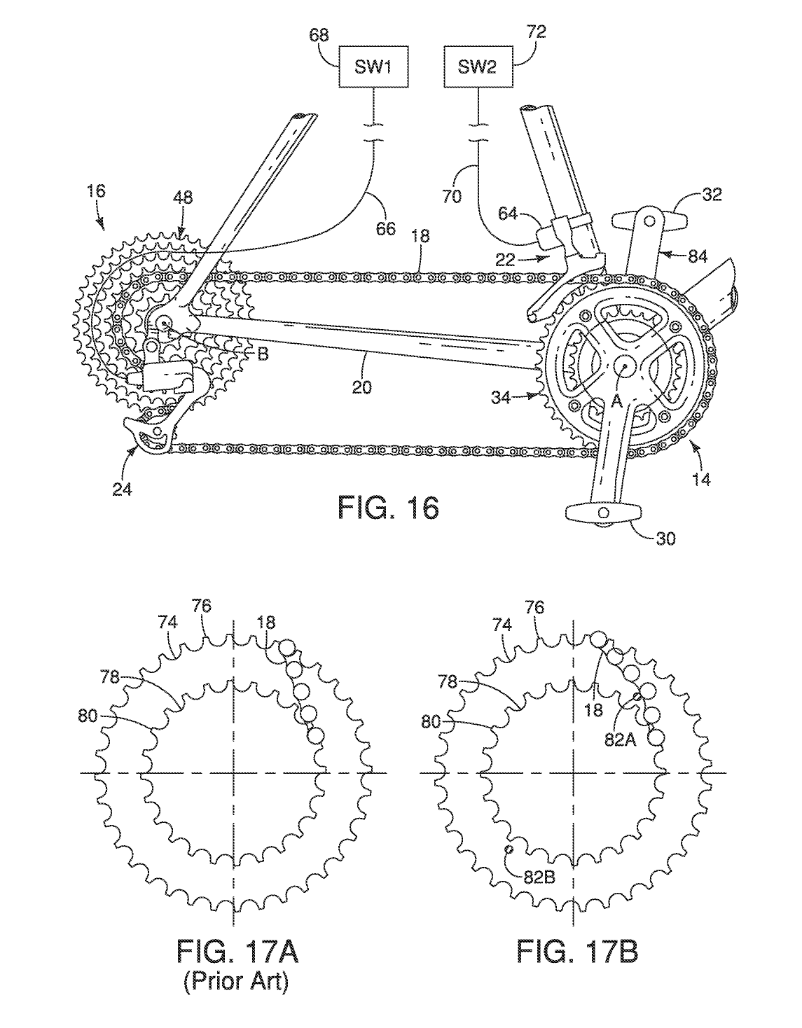

A front shifting device is disposed adjacent to the front sprocket assembly 34 and a rear shifting device is disposed adjacent to the rear sprocket assembly 48, as shown in FIG. 1. The front derailleur 22 and the rear derailleur 24 are examples of front and rear shifting devices, respectively. Any suitable shifting device can be used to facilitate shifting, such as mechanical or electrical shifting devices. For example, as illustrated in FIG. 1, the front and rear derailleurs 22 and 24 are mechanical shifting devices configured to be operated by movement of the bicycle control cables 26 and 28, respectively. At least one of the front shifting device and the rear shifting device is configured to be operated by movement of a bicycle control cable. Alternatively, as illustrated in FIG. 16, electrical switches 68 (SW1) and 72 (SW2) send signals through control cables 66 and 70 to motors 62 and 64 to operate the rear and front shifting devices 24 and 22, respectively. Alternatively, the front shifting device can be a power change mechanism. Alternatively, the rear shifting device can be an internal transmission hub.

As illustrated in FIG. 17B, a second rear-sprocket 74 includes at least one shift assist projection 82A. Preferably, the second rear-sprocket 74 includes a plurality of shift assist projections 82A and 82B. The shift assist projections 82A and 82B are connected to a face of the second-rear sprocket 74 facing the adjacent smaller sprocket 78. The shift assist projections 82A and 82B facilitate down-shifting from the smaller sprocket 78 to the larger sprocket 74. As the chain 18 is released from the teeth 80 of the smaller sprocket 78, the chain 18 engages one of the shift assist projections 82A and 82B, as illustrated in FIG. 17B, thereby facilitating engagement of the chain 18 with teeth 76 of the larger sprocket 74. The shift assist projections 82A and 82B engage the chain 18 to reduce the angle with which the chain approaches the teeth 76 of the larger sprocket 74 during down-shifting, thereby facilitating engagement of the chain 18 with the teeth 76. As illustrated in FIG. 17A, the chain 18 approaches the teeth 76 of the larger sprocket 74 at a greater angle, such that the down-shifting process is less smooth.

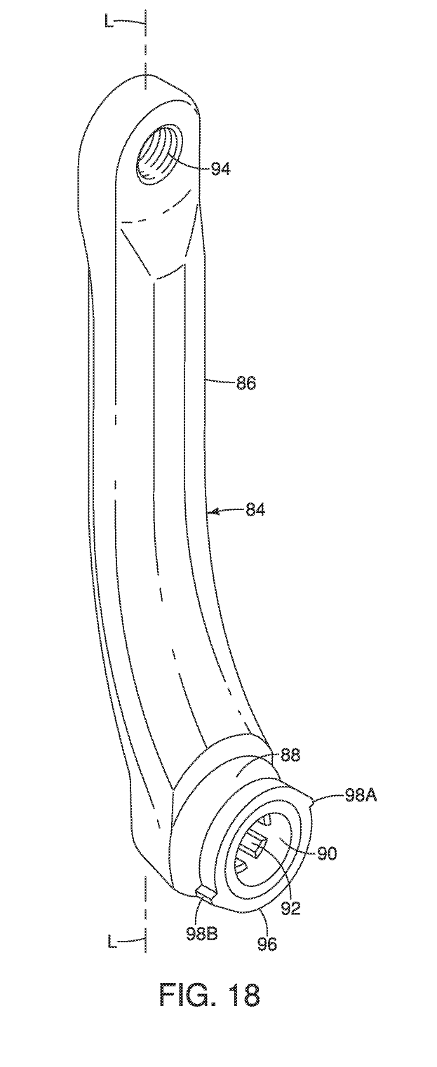

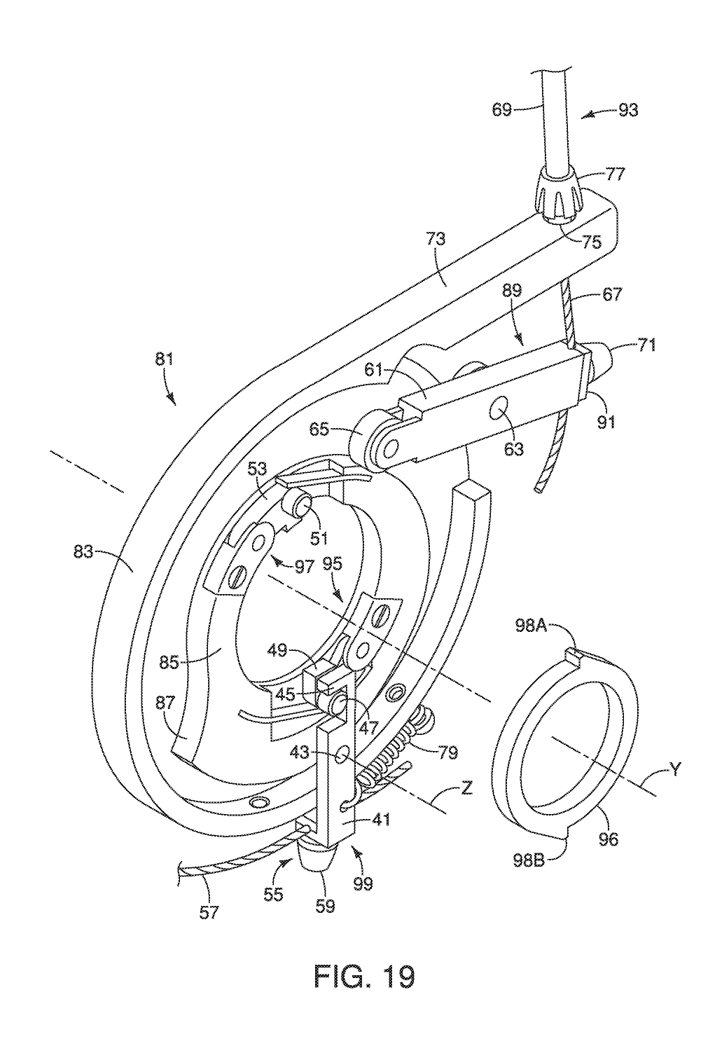

With reference to FIGS. 18 and 19, at least one of the front shifting device and the rear shifting device is configured to be operated by rotation of a bicycle crank arm. A left side crank arm assembly 84 is illustrated in FIG. 18, and includes an elongated crank arm body 86, a crank arm mounting boss 88 at a first end having an inner peripheral surface defining the crank axle mounting hole 90 and splines 92 and a threaded pedal mounting hole 94 on a second end. An assisting apparatus 81 described below is disposed on a left side of a bottom bracket shell. Alternatively, the assisting apparatus can be disposed on a right side of the bottom bracket shell.

An annular drive ring 96 has an inner peripheral surface non-rotatably engaging an outer peripheral surface of a crank axle mounting boss 88. Preferably, the annular drive ring 96 is press-fit onto the crank axle. Projections 98A and 98B are preferably not greater than, and preferably less than, an outer diameter of the crank arm mounting boss 88 transverse to a longitudinal median axis L of the crank arm 86.

An oblique view of an exemplary embodiment of an assisting apparatus 81 is illustrated in FIG. 19. The assisting apparatus 81 includes mounting member 83, a cam member (derailleur positioning cam) 85 with a cam surface 87 coupled to a mounting member 83 for rotation around a cam axis Y (which is usually but not necessarily coincident with the rotation axis A of crank arm assembly 42), a cam follower 89 cooperating with the cam surface 87 for moving in response to rotation of the cam member 85, a transmission actuating element coupling member 91 for communicating movement of the cam follower 89 to a transmission actuating element 93, a first coupling member 95 coupled for rotation of cam member 85, wherein the first coupling member 95 moves between a first engaged position and a first disengaged position, a second coupling member 97 coupled for rotation of the cam member 85, wherein the second coupling member 97 moves between a second engaged position and a second disengaged position, and an operating member 99 for moving the first coupling member 95 to the first engaged position.

The cam follower 89 includes a cam follower lever 61, wherein an intermediate portion of cam follower lever 61 is pivotably mounted to the mounting member 83 through a pivot shaft 63. A first end of the cam follower lever 61 includes a roller 65 for engaging the cam surface 87, and a second end of the cam follower lever 61 contains the transmission actuating element coupling member 91. The transmission actuating element 93 includes a Bowden cable wherein transmission actuating wire 67 slides within an outer casing 69. Thus, the transmission actuating element coupling member 91 has the form of a wire connector, wherein a wire fastening screw 71 screws into the second end of the cam follower lever 61. A mounting member 83 has a transmission actuating element coupling arm 73 for terminating the outer casing 69 of the transmission actuating element in a known manner. For example, the transmission actuating element coupling arm 73 may have a threaded opening for engaging a threaded portion 75 of an adjustment barrel 77 used to terminate the outer casing 69 and to adjust the position of the outer casing 69 relative to the transmission actuating wire 67.

The operating member 99 has the shape of an operating lever 41, wherein an intermediate portion of the operating leer 41 is pivotably mounted to the mounting member 83 through a pivot shaft 43 for pivoting around an operating lever axis Z. A first end of the operating lever 41 has the shape of a hook with a control surface 45 for supporting either a first pawl control abutment 47 of the first pawl 49 or a second pawl control abutment 51 of a second pawl 53. A second end of the operating lever 41 includes an operating element coupling member 55. The illustrated operating element is in the form of an operating wire 57 coupled between a shift operating device mounted to the bicycle handlebar (not shown) and the operating element coupling member 55. Thus, the operating coupling member 55 has the form of a wire connector, wherein a wire fastening screw 59 screws into the second end of the operating lever 41. An operating member biasing spring 79 is connected between the mounting member 83 and the operating lever 41 for biasing the operating lever 41 counterclockwise. FIGS. 18 and 19 illustrate an exemplary embodiment in which at least one of the front and rear shifting devices is configured to be operated by rotation of a bicycle crank arm. Alternatively, any suitable configuration of bicycle crank arm can be used to operate at least one of the front and rear shifting devices.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “attached” or “attaching”, as used herein, encompasses configurations in which an element directly secured to another element by affixing the element is directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Also, the terms “part,” “section,” “portion,” “member” or “element” when used in the singular can have the dual meaning of a single part or a plurality of parts. Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Moreover, the size, shape, location or orientation of the various components can be changed as needed and/or desired so long as they do not substantially their intended function. Components that are shown directly connected or contacting each other can have intermediate structures disposed between them unless specifically stated otherwise. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle drive system comprising:
a front sprocket assembly including
a first front-sprocket having a first front-tooth number that is the largest tooth number in the front sprocket assembly; and
a second front-sprocket having a second front-tooth number that is less than or equal to the first front-tooth number, the second front-sprocket being adjacent to the first front-sprocket without another sprocket intervening therebetween in an axial direction;
the first front-tooth number being less than or equal to 40.

2. The bicycle drive system according to claim 1, wherein
the first front-tooth number divided by the second front-tooth number is less than or equal to 1.4.

3. The bicycle drive system according to claim 1, wherein
the first front-tooth number divided by the second front-tooth number is less than or equal to 1.2.

4. The bicycle drive system according to claim 1, wherein
the first front-tooth number is less than or equal to 34.

5. The bicycle drive system according to claim 4, wherein
the second front-tooth number is less than or equal to 30.

6. The bicycle drive system according to claim 1, further comprising
a rear sprocket assembly including a first rear-sprocket having a first rear-tooth number less than or equal to 10 and a second rear-sprocket having a second rear-tooth number greater than or equal to 44.

7. The bicycle drive system according to claim 1, wherein
the rear sprocket assembly further comprises at least 5 additional rear-sprockets positioned between the first rear-sprocket and the second rear-sprocket in an axial direction parallel to a rotational central axis of the rear sprocket assembly.

8. The bicycle drive system according to claim 7, wherein
the rear sprocket assembly has a total of seven rear-sprockets.

9. The bicycle drive system according to claim 6, wherein
the first rear-tooth number is 10; and
the second rear-tooth number is 46.

10. The bicycle drive system according to claim 6, wherein
the first rear-tooth number is 10; and
the second rear-tooth number is 50.

11. The bicycle drive system according to claim 6, wherein
the first front-tooth number is 34; and
the second front-tooth number is 30.

12. The bicycle drive system according to claim 6, wherein
the first front-tooth number is 32; and
the second front-tooth number is 28.

13. The bicycle drive system according to claim 6, wherein
the second rear-sprocket includes at least one shift assist projection.

14. The bicycle drive system according to claim 13, wherein
the second rear-sprocket includes a plurality of shift assist projections.

15. The bicycle drive system according to claim 6, further comprising
a front shifting device disposed adjacent to the front sprocket assembly and a rear shifting device disposed adjacent to the rear sprocket assembly.

16. The bicycle drive system according to claim 15, wherein
at least one of the front shifting device and the rear shifting device is configured to be operated by rotation of a bicycle crank arm.

17. The bicycle drive system according to claim 15, wherein
at least one of the front shifting device and the rear shifting device is configured to be operated by movement of a bicycle control cable.

18. The bicycle drive system according to claim 15, wherein
at least one of the front shifting device and the rear shifting device is configured to be operated in accordance with a prescribed shifting route.

19. The bicycle drive system according to claim 18, wherein
the prescribed shifting route includes at least one of a prescribed up-shifting route and a prescribed down-shifting route.

20. The bicycle drive system according to claim 19, wherein
the prescribed shifting route includes the prescribed up-shifting route and the prescribed down-shifting route.

21. The bicycle drive system according to claim 6, wherein
the first front-tooth number divided by the second front-tooth number is less than or equal to a large rear-sprocket tooth number of a large rear sprocket divided by a small rear-sprocket number of a small rear sprocket adjacent to the large rear sprocket without another rear sprocket intervening therebetween in the axial direction.

22. The bicycle drive system according to claim 6, wherein
the first front-tooth number divided by the second front-tooth number is less than a large rear-sprocket tooth number of a large rear sprocket divided by a small rear-sprocket number of a small rear sprocket adjacent to the large rear sprocket without another rear sprocket intervening therebetween in the axial direction.

23. The bicycle drive system according to claim 6, wherein
a large rear-sprocket tooth number of a large rear sprocket divided by a small rear-sprocket number of a small rear sprocket adjacent to the large rear sprocket without another rear sprocket intervening therebetween in the axial direction is greater than 1.27.
